(19) United States
(12) Patent Application Publication
(10) Pub. No.: US 2008/0131709 A1
(43) Pub. Date: Jun. 5, 2008

(54) COMPOSITE STRUCTURE WITH ORGANOPHOSPHONATE ADHERENT LAYER AND METHOD OF PREPARING

(75) Inventors: Eric L. Hanson, San Diego, CA (US); Gerry W. Gruber, Englewood, FL (US); Eric L. Bruner, San Diego, CA (US)

Correspondence Address: BLYNN L. SHIDELER;THE BLK LAW GROUP, 3500 BROKKTREE ROAD, SUITE 200, WEXFORD, PA, 15090, US

(73) Assignee: ACULON INC., San Diego, CA (US)

(21) Appl. No.: 11/862,175

(22) Filed: Sep. 26, 2007

Related U.S. Application Data
(60) Provisional application No. 60/827,367, filed on Sep. 28, 2006.

(51) Int. Cl. B32B 15/04

(52) U.S. Cl. 428/457; 156/151

(57) ABSTRACT

The present invention provides an article comprising: a substrate having a surface and comprising electrodeposited copper foil or copper alloy foil; an adherent layer serving to promote adhesion, comprising at least one organophosphonate or salt thereof covalently bound to the surface; and a functional layer, comprising at least one polymer bound to the adherent layer. The present invention further provides devices comprising a heat source or electronic component and the article described above, wherein the heat source is in thermal contact with the substrate and the electronic component is in electrical contact with the substrate.

Also provided is a method of producing the above-described article.

### FIELD OF THE INVENTION

The present invention relates to multi-layer articles comprising a substrate, an organophosphonate adherent layer, and a functional layer, and methods of preparing them.

### BACKGROUND OF THE INVENTION

The application of polymeric coatings and films to metal substrates has been used in many technologies and products. The automotive, building and electronics industries are just a few representative fields where coatings and films are applied to metals to form composite articles that may be used in the fabrication of commercial products.

Coatings are typically applied to substrates in order to provide thermal and/or electrical conductivity or insulation, protection from corrosion, structural integrity, and aesthetic appeal, among other advantages.

Initial and prolonged adhesion of the coating to the substrate can be a concern, depending on the respective natures of the substrate and coating, as well as the conditions to which the final product will be subjected during use. Steel and copper alloy substrates are commonly employed in the automotive and electronics industries respectively, with various polymeric coatings and films applied thereto. In the past, chromium-containing coatings have been used on these substrates for corrosion protection and adhesion promotion. Although chromium-containing coatings provide excellent corrosion protection, they are toxic and present waste disposal problems. Therefore, there is a need for chromium-free treatment solutions for treating metal substrates in conjunction with the subsequent application of a polymeric coating. The treatment solution should provide corrosion resistance and maintain substrate adhesion to the polymer.

It would be desirable to provide a multi-layer coated article that demonstrates corrosion resistance and adhesion while avoiding the toxicity drawbacks of the prior art.

### SUMMARY OF THE INVENTION

The present invention provides an article comprising: a substrate having a surface and comprising electrodeposited copper foil or copper alloy foil; an adherent layer serving to promote adhesion, comprising at least one organophosphonate or salt thereof covalently bound to the surface; and a functional layer, comprising at least one polymer bound to the adherent layer. The present invention further provides devices comprising a heat source or electronic component and the article described above, wherein the heat source is in thermal contact with the substrate and the electronic component is in electrical contact with the substrate.

Also provided is a method of producing the above-described article, comprising:
a) providing a substrate having a surface and comprising electrodeposited copper foil or copper alloy foil;
b) contacting the surface of the substrate with a composition comprising at least one phosphorous acid moiety selected from the group consisting of organophosphonic acid, phosphonic acid, conjugate base thereof, salt thereof, and a combination thereof, to form an adherent layer comprising at least one organophosphonate or salt thereof covalently bound to the surface;
c) contacting the adherent layer with at least one polymer, to covalently bind the polymer to the adherent layer and form a functional layer; and optionally
d) after contacting the adherent layer with the polymer, one or more steps selected from the group consisting of curing the polymer, drying the polymer, heating the polymer, and a combination thereof.

### DETAILED DESCRIPTION OF THE VARIOUS EMBODIMENTS

The substrate used to prepare the articles of the present invention have a surface and may, for example, comprise copper foil or copper alloy foil. The copper or copper alloy may be deposited onto a manufacturing surface and then removed to form a free foil. Alternatively, the copper or copper alloy may be deposited onto a core material to form a multi-layer or composite substrate. Suitable substrates to be used as the core are any electrically conductive materials. For example, suitable metals include copper foil, iron-nickel (Fe—Ni) alloys, and combinations thereof. A particularly suitable iron-nickel alloy is Invar, (trademark owned by Imphy S. A., 168 Rue de Rivoli, Paris, France) comprising approximately 64 weight percent iron and 36 weight percent nickel. This alloy has a low coefficient of thermal expansion. When a nickel-iron alloy is used as the electrically conductive core, a layer of copper metal is typically applied to all surfaces of the electrically conductive core to ensure optimum conductivity. The layer of copper metal may be applied by conventional means, such as electroplating or metal vapor deposition. The layer of copper often has a thickness of from 1 to 8 microns.

The surface of the substrate may be substantially planar, curved, uniform, non-uniform, or any combination thereof.

The metal substrate may be smooth, for example, atomically smooth, or it may be rough, for example having a roughness on a micron scale, or anywhere in between. In certain embodiments of the present invention, the surface of the substrate is chemically or mechanically roughened. Surface roughening may be achieved by several methods. The electrodeposited copper foils can be electroformed with a rough surface. On top of this rough surface further roughening is carried out by applying a high surface area treatment. These treatments may be a copper deposited electrolytically in nodular or powder form, or a copper oxide which grows nodular or dendritic, among others. Often times the rolled copper foil has mechanical roughness imparted to it during rolling or by subsequent abrasion. Rolled foils may also be treated with surface area increasing nodular copper or copper oxide. The surface roughness, Ra, may suitably range from 0.01 to 5 μm. This range includes all values and subranges therebetween, including 0.01, 0.025, 0.05, 0.075, 0.1, 0.25, 0.5, 0.75, 1, 2, 3, 4, 5 μm, and any combination thereof.

The metal substrate may be in any form such as rolled, cast, extruded, forged, profiled, sheet stock, patterned, stamped, strip, wheel, parts for aircraft industry, for apparatuses, for automobile industry, for electronic industry, for beverage and other food containers, for construction or for engineering.

The metal substrate may be structural, insulating, semi-insulating, electrically conductive, semi-conductive, thermally conductive, thermally insulating, radiation absorbing, radiation reflecting, or any combination thereof.

The metal substrate may have a thickness of 5 mm or less. This range includes all values and subranges therebetween, including 5, 4, 3, 2, 1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01 mm or less, and any combination thereof.

The dimension of the substrate may be suitably selected as appropriate. The substrate can have any dimension, having widths and/or lengths, for example, independently ranging from 1 mm to 1000 mm or larger. This range includes all values and subranges therebetween, including 1, 2, 3, 4, 5, 6, 7, 8, 9, 10, 20, 25, 50, 75, 100, 250, 500, 750, 1000 mm, and any combination thereof.

As noted above, the substrate may comprise an alloy of copper, or oxide thereof, and at least one other metal selected from the group including silver, gold, nickel, palladium, platinum, zinc, titanium, zirconium, vanadium, niobium, tantalum, chromium, molybdenum, tungsten, manganese, iron, ruthenium, osmium, cobalt, zinc, cadmium, aluminum, tin, lead, magnesium, indium, arsenic, antimony, gallium, germanium, bismuth, selenium, tellurium, rhodium, iridium, thallium, silicon, rhenium, scandium, yttrium, oxide thereof, and combination thereof.

The substrate surface may include one or more of copper, oxide thereof, salt thereof, halide thereof, sulfate thereof, phosphate thereof, hydroxide thereof, chalcogenide thereof, alkoxide thereof, nitrate thereof, fluoride thereof, chloride thereof, bromide thereof, iodide thereof, sulfide thereof, or a combination thereof.

The substrate surface may include one or more of copper, silver, gold, nickel, palladium, platinum, zinc, titanium, zirconium, vanadium, niobium, tantalum, chromium, molybdenum, tungsten, manganese, iron, ruthenium, osmium, cobalt, zinc, cadmium, aluminum, tin, lead, oxide thereof, halide thereof, sulfate thereof, phosphate thereof, hydroxide thereof, chalcogenide thereof, alkoxide thereof, nitrate thereof, fluoride thereof, chloride thereof, bromide thereof, iodide thereof, sulfide thereof, or a combination thereof.

The surface may include one or more of NiCr, titanium alkoxide, zirconium alkoxide, ZnO, TiO₂, Fe₂O₃, Al₂O₃, SnO₂, Cr₂O₃, or a combination thereof.

The organophosphonate used in the adherent layer of the articles of the present invention may be derived from an organophosphonic acid moiety having the formula:

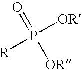

or conjugate base thereof, or salt thereof;
wherein R is a C₁₋₄₀ branched or unbranched, substituted or unsubstituted, saturated or unsaturated aromatic, cyclic, or aliphatic group, optionally having one or more carbons independently replaced with one or more heteroatoms such as S, N, O, P, or a combination thereof;
wherein R′ is hydrogen or a C₁₋₄₀ branched or unbranched, substituted or unsubstituted, saturated or unsaturated aromatic, cyclic, or aliphatic group, optionally having one or more carbons independently replaced with one or more heteroatoms such as S, N, O, P, or a combination thereof; and
wherein R″ is hydrogen or a C₁₋₄₀ branched or unbranched, substituted or unsubstituted, saturated or unsaturated aromatic, cyclic, or aliphatic group, optionally having one or more carbons independently replaced with one or more heteroatoms such as S, N, O, P, or a combination thereof.

The organophosphonic acid moiety may be a substituted or unsubstituted, branched or unbranched, saturated or unsaturated organophosphonic acid or salt thereof. Some examples of these include alkylphosphonic acid, perfluoroalkylphosphonic acid, hydroxyalkylphosphonic acid, vinylalkylphosphonic acid, phosphonoalkylphosphonic acid, carboxyalkyphosphonic acid, sulfonoalkylphosphonic acid, aminoalkylphosphonic acid, amidoalkylphosphonic acid, siloxyalkylphosphonic acid, alkoxyalkylphosphonic acid, allylalkyl-aryl phosphonic acid, arylalkylphosphonic acid, aldehydealkylphosphonic acid, trifluoromethylalkylphosphonic acid, thioalkylphosphonic acid, epoxyalkylphosphonic acid, nitroalkylphosphonic acid, branched C₃₋₄₀ phosphonic acid, unbranched C₁₋₄₀ phosphonic acid, substituted C₁₋₄₀ phosphonic acid, unsubstituted C₁₋₄₀ phosphonic acid, saturated C₁₋₄₀ phosphonic acid, unsaturated C₂₋₄₀ phosphonic acid, aromatic C₅₋₄₀ phosphonic acid, aliphatic C₁₋₄₀ phosphonic acid, cyclic C₃₋₄₀ phosphonic acid, C₂₋₄₀ phosphonic acid having one or more carbons substituted by S, C₂₋₄₀ phosphonic acid having one or more carbons substituted by N, C₂₋₄₀ phosphonic acid having one or more carbons substituted by O, C₂₋₄₀ phosphonic acid having one or more carbons substituted by P, C₁₋₄₀ phosphonic acid having one or more carbons substituted by a combination of two or more S, N, O, P, salt thereof, or a combination thereof.

Other examples of the organophosphonic acid moiety include 11-hydroxyundecylphosphonic acid, 11-acetoxyundecylphosphonic acid, 1-acetoxyundecylphosphonic acid, undec-11-enephosphonic acid, p-aminobenzylphosphonic acid, p-nitrobenzylphosphonic acid, 4-mercaptobutylphosphonic acid, butane-1,4-bisphosphonic acid, but-2-ene-1,4,-bisphosphonic acid, o-phenolphosphonic acid, m-phenolphosphonic acid, p-phenolphosphonic acid, 2 methoxy-4-prop-2-enylphenol-6-phosphonic acid, 1-phosphonic acid-12-mercaptododecane, 1-phosphonic acid-12-(N-ethylamino)dodecane, 1-phosphonic acid-12-dodecene, p-xylylene diphosphonic acid, 1,10-decanediphosphonic acid, 1,12-dodecanediphosphonic acid, 1,14-tetradecanediphosphonic acid, 1-phosphonic acid-12-hydroxydodecane, 1-phosphonic acid-12-(N-ethylamino)dodecane, 1-phosphonic acid-12-dodecene, 1-phosphonic acid-12-mercaptododecane, 1,10-decanediphosphonic acid, 1,12-dodecanediphosphonic acid, 1,14-tetradecanediphosphonic acid, p,p′-biphenyldiphosphonic acid, 1-phosphonic acid-12-acryloyldodecane, 1,8-octanediphosphonic acid, 1,6-hexanediphosphonic acid, 1,4-butanediphosphonic acid, 1,8-octanediphosphonic acid, 1,6-hexanediphosphonic acid, 1,4-butanediphosphonic acid, aminetrimethyleneposphonic acid, ethylenediaminetetramethylenephosphonic acid, hexamethylenediaminetetramethylenephosphonic acid, diethylenetriaminepentamethylenephosphonic acid, 2-phosphonobutane-1,2,4-tricarboxylic acid, or a combination thereof.

The organophosphonate may have one of the following formulas:

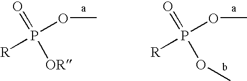

or salt thereof;
wherein R is branched or unbranched, substituted or unsubstituted, saturated or unsaturated, aromatic, cyclic, or aliphatic C₁₋₄₀ group, optionally having one or more carbons independently replaced with one or more heteroatoms such as S, N, O, P, or a combination thereof;
wherein R″ is hydrogen or a C₁₋₄₀ branched or unbranched, substituted or unsubstituted, saturated or unsaturated aromatic, cyclic, or aliphatic group, optionally having one or more carbons independently replaced with one or more heteroatoms such as S, N, O, P, or a combination thereof;
wherein a is a covalent bond to the surface; and
wherein b is an electron pair or a bond to at least one of the surface, an organophosphonate, an organophosphonic acid, a phosphonate, a phosphonic acid, a metal, an ion, a neighboring molecule, or a combination thereof.

The organophosphonate may be a substituted or unsubstituted, branched or unbranched, saturated or unsaturated organophosphonate or salt thereof. Examples of these include alkylphosphonate, perfluoroalkylphosphonate, hydroxyalkylphosphonate, vinylalkylphosphonate, phosphonoalkylphosphonate, carboxyalkyphosphonate, sulfonoalkylphosphonate, aminoalkylphosphonate, amidoalkylphosphonate, siloxyalkylphosphonate, alkoxyalkylphosphonate, allylalkyl-aryl phosphonate, arylalkylphosphonate, aldehydealkylphosphonate, trifluoromethylalkylphosphonate, thioalkylphosphonate, epoxyalkylphosphonate, nitroalkylphosphonate, branched C₃₋₄₀ phosphonate, unbranched C₁₋₄₀ phosphonate, substituted C₁₋₄₀ phosphonate, unsubstituted C₁₋₄₀ phosphonate, saturated C₁₋₄₀ phosphonate, unsaturated C₂₋₄₀ phosphonate, aromatic C₅₋₄₀ phosphonate, aliphatic C₁₋₄₀ phosphonate, cyclic C₃₋₄₀ phosphonate, C₂₋₄₀ phosphonate having one or more carbons substituted by S, C₂₋₄₀ phosphonate having one or more carbons substituted by N, C₂₋₄₀ phosphonate having one or more carbons substituted by O, C₂₋₄₀ phosphonate having one or more carbons substituted by P, C₁₋₄₀ phosphonate having one or more carbons substituted by a combination of two or more S, N, O, P, salt thereof, or a combination thereof.

The adherent layer may also include at least one phosphorous acid moiety such as organophosphonic acid, phosphonic acid, salt thereof, conjugate base thereof, metal oxide thereof, or a combination thereof.

In one embodiment, the phosphorous acid moiety has the formula:

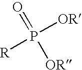

wherein R, R′, R″ are each independently H or a C₁₋₄₀ branched or unbranched, substituted or unsubstituted, saturated or unsaturated, aromatic, cyclic, or aliphatic group, optionally having one or more carbons independently replaced with one or more heteroatoms such as S, N, O, P, or a combination thereof;
or salt thereof,
or conjugate base thereof,
or metal oxide thereof.

By conjugate base it is meant the anion that is formed via loss of one or more protons.

By salt it is meant the compound formed from a conjugate base and one or more non-proton counterions. Some examples of counterions include those of sodium, potassium, calcium, ammonia, triethylammonia, trimethylammonia, EDTA, zirconium, magnesium, and the like. Combinations of counterions are possible.

By metal oxide it is meant the compound having one or more metal-oxygen bonds. One example includes a phosphonic acid metal ester having a P—O-M bond wherein M is a metal.

The aromatic group may be a C₅-C₄₀ aromatic group in which one or more carbons may be independently and optionally replaced with one or more heteroatoms such as S, N, O, P, or a combination thereof. This range includes all values and subranges therebetween, including C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈, C₃₉, C₄₀. It may be substituted or unsubstituted, branched or unbranched. It may be monocyclic or a plurality of rings.

The cyclic group may be a C₃-C₄₀ cyclic group in which in which one or more carbons may be independently and optionally replaced with one or more heteroatoms such as S, N, O, P, or a combination thereof. This range includes all values and subranges therebetween, including C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈, C₃₉, C₄₀. It may be substituted or unsubstituted, saturated or unsaturated, branched or unbranched. It may be monocyclic or a plurality of cyclic rings.

The aliphatic group may be a C₁₋₄₀ aliphatic group in which one or more carbons may be independently and optionally replaced with one or more heteroatoms such as S, N, O, P, or a combination thereof. This range includes all values and subranges therebetween, including C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈, C₃₉, C₄₀ aliphatic group. It may be branched or unbranched, substituted or unsubstituted, saturated or unsaturated.

If substituted, the C₅-C₄₀ aromatic group, C₃-C₄₀ cyclic group, and/or C₁₋₄₀ aliphatic group may be independently substituted with one or more substituents such as hydroxyl, halo, bromo, chloro, iodo, fluoro, —OR′, —NR′R″, —NR′COR″, —CONR′R″, —CONR′, —COOR′, —OCOR′, —COR′, —SR′, —SO₂R′, —SO₃R′, —SO₂NR′, —SOR′, —N₃, —CN, —NC, —SH, —NO₂, —NH₂, —PR′₂, —(O)PR′R′, —PO₃R′R″, —OPO₃R′R″, —PO₂, (C₁-C₂₀) alkyl, phenyl, (C₃-C₂₀) cycloalkyl, (C₁-C₂₀) alkoxy, (C₃-C₂₅) heteroaryl, (C₃-C₂₅) heterocyclyl, (C₂-C₂₀) alkenyl, (C₄-C₂₀) cycloalkenyl, (C₂-C₂₀) alkynyl, (C₆-C₂₀) cycloalkynyl, (C₅-C₂₅) aryl, perhalo (C₁-C₂₀) alkyl, salt thereof, or a combination thereof. The substituents may be branched or unbranched or saturated or unsaturated as appropriate.

If unsaturated, the C₅-C₄₀ aromatic group, C₃-C₄₀ cyclic group and/or C₁₋₄₀ aliphatic group and/or their substituents may contain one or more double bonds, triple bonds, sites of conjugation, or combinations thereof.

The adherent layer serves to promote adhesion between the substrate and the functional layer, and may be a monolayer, bilayer, or combination thereof. It may be mixed monolayer, mixed bilayer, or combination thereof. By “mixed” is meant that more than one organophosphonate compound is used.

The adherent layer may be a self-assembled layer. For example, the organophosphonate compounds and/or the organophosphonate moiety from which they may be derived form self assembling molecules which organize themselves parallel or substantially parallel one to one another. The molecules in the adherent layer may be perpendicular or substantially perpendicular to the surface, or they may be arranged at some other angle relative to the surface. The molecules may not be so organized in the adherent layer, however. The adherent layer may be uniform or may be a random distribution of islands of molecules. The entire surface or a portion of the surface may be covered by the adherent layer. Omega-functional organophosphonic acids are particularly suitable in the formation of self-assembled layers.

The phosphorous acid moiety may be bonded to the surface or not bonded to the surface; i.e., the phosphorous acid functional group may or may not be reacted with the substrate surface. A second functional group such as hydroxyl, amino, thio, carboxyl, mercapto, etc., that is integral to the organophosphonate molecule may be reacted with the substrate surface, leaving the phosphorous acid moiety free to react with the subsequently applied functional layer. If bonded to the substrate surface, the phosphorous acid moiety may be bonded to the surface with a bond such as a covalent bond, ionic bond, coordination, Van der Waals interaction, chemisorption, physisorption, or a combination thereof.

The adherent layer may have a thickness ranging from about 0.5 nm to 5000 nm. This range includes all values and subranges therebetween, including 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000 nm, and any combination thereof.

The functional layer of the article, comprising at least one polymer bound to the adherent layer, serves at least one physical function in the article, for example, thermal conductivity or insulation, electrical conductivity or insulation, and/or corrosion protection. The polymer in the functional layer may be a thermoplastic, thermoset, copolymer thereof, or a combination thereof, for example.

Some examples of the polymer include elastomer, epoxy (polyepoxide), Bisphenol-A epoxy, polyester, polycarbonate, polyphenol, polymercaptan, polyene, polyolefin, polypropylene, polyethylene, polybutylene, polyamide, polyether, polythiophene, polypyrrole, polyimide, polysulfone, polybenzimidazole, polybenzoxazole, poly(p-phenylene), polyquinoline, polyquinoxaline, polysulfide, poly(p-xylylene), polysiloxane, polyurethane, polyphosphazine, alkyd, acrylic, polyvinyl chloride, polystyrene, polyvinyl acetate, polyvinyl alcohol, copolymer thereof, or a combination thereof.

The functional layer may suitably include one or more of a dielectric polymer, conducting polymer, semiconducting polymer, thermally conductive polymer, thermally insulating polymer, light emitting polymer, adhesive polymer, minimally adhesive polymer, anticorrosive polymer, antifouling polymer, radiation-reflecting polymer, soluble polymer, photodegradable polymer, photocuring polymer, photoresist polymer, copolymer thereof, a polyepoxide coating, a polymer-impregnated composite, such as an epoxy-impregnated fiberglass, carbon fiber, or silica composite layer, or combination thereof as appropriate.

One or more polymers of the functional layer may be bound to the adherent layer with a bond such as a covalent bond, ionic bond, coordination, Van der Waals interaction, chemisorption, physisorption, or a combination thereof. The organophosphonates should be chosen to ensure bonding of the functional polymer to the surface through the organophosphonate linker, and for best results it is important to consider the necessary functional groups to ensure bonding. In one embodiment, a plurality of polymers is thus bound to the adherent layer. In one embodiment, one or more of the functional layer polymers is bound to the organophosphonate.

The functional layer may have a thickness ranging from about 10 nm to 5 mm. This range includes all values and subranges therebetween, including 10, 20, 30, 40, 50, 60, 70, 80, 90, 100, 200, 300, 400, 500, 600, 700, 800, 900 nm, 1, 2, 3, 4, 5, 6, 7, 8, 9, 10, 20, 40, 60, 80, 100, 200, 400, 600, 800 μm, 1, 2, 3, 4, 5 mm, and any combination thereof.

In one embodiment, the functional layer contains less than about 0.1 wt % of organophosphonate, organophosphonic acid, phosphonic acid, phosphonate, or a mixture thereof, based on the weight of the functional layer. This range includes all values and subranges therebetween, including less than about 0.1, 0.09, 0.08, 0.07, 0.06, 0.05, 0.04, 0.03, 0.02, 0.01 wt. % or less, and any combination thereof.

In accordance with the present invention, a method for producing an article as described above comprises:
a) providing a substrate having a surface and comprising electrodeposited copper foil or copper alloy foil;
b) contacting the surface of the substrate with a composition comprising at least one phosphorous acid moiety selected from the group consisting of organophosphonic acid, phosphonic acid, conjugate base thereof, salt thereof, and a combination thereof, to form an adherent layer comprising at least one organophosphonate or salt thereof covalently bound to the surface;
c) contacting the adherent layer with at least one polymer, to covalently bind the polymer to the adherent layer and form a functional layer; and optionally
d) after contacting the adherent layer with the polymer, one or more steps selected from the group consisting of curing the polymer, drying the polymer, heating the polymer, and a combination thereof. Multiple-layered articles may be prepared as desired in accordance with the present invention by repeating the contacting steps b) and c) on a second surface of the substrate, and/or by contacting the functional layer with a composition comprising at least one phosphorous acid moiety to form an additional adherent layer for subsequent attachment of additional articles, substrates, or polymeric functional layers.

The surface of the substrate may be cleaned and/or degreased prior to applying the adherent layer. Some examples of surface cleaning include contacting the surface with alkaline solution, solvent, acidic solution, or any combination thereof. The surface may be cleaned with H₂SO₄ solution. The surface may be pickled prior to forming the adherent layer.

To prepare the adherent layer, the substrate surface may be contacted with a coating solution containing the organophosphonic acid moiety by dipping, immersing, roll-coating, squeegeeing, vapor deposition, brushing, spraying, or any combination thereof.

The coating solution may contain the phosphorous acid moiety in an amount ranging from 0.01 mmol to 10 mmol. This range includes all values and subranges therebetween, including 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10 mmol, and any combination thereof. The coating solution, and hence the resulting adherent layer formed on the substrate, is essentially free of chromium.

The surface may be contacted with the coating solution for a time ranging from 1 second to 1 hour. This range includes all values and subranges therebetween, including 1, 2, 3, 4, 5, 6, 7, 8, 9, 10, 20, 30, 40, 50, 60 seconds, 2, 3, 4, 5, 6, 7, 8, 9, 10, 20, 30, 40, 50, 60 minutes, and any combination thereof.

The surface may be contacted with the coating solution at a temperature ranging from 5 to 60° C. This range includes all values and subranges therebetween, including 5, 6, 7, 8, 9, 10, 15, 20, 25, 30, 40, 50, 60° C. and any combination thereof. The surface may be contacted with one or more coating solutions, in any order, or repeated as desired.

The coated surface may be contacted with one or more rinsing compositions containing solvents as appropriate, in any order, or repeated as desired.

The coating solution and/or, if desired, the rinsing composition, may independently include at least one selected from the group including water, ethanol, methanol, propanol, butanol, isopropanol, isobutanol, acetic acid, tetrahydrofuran, alcohol, acetone, dioxane, tetrahydrofuran, glycol ether, n-propyl glycol ether, 2-(2-ethoxyethoxy)ethanol, 2-butoxyether, monoalkoxy glycol ether, 2-butoxyethanol, DOWANOL™, fluorinated solvent, aliphatic hydrocarbon, ether, ester, dimethyl sulfonic acid, toluene, solvent, co-solvent, polar solvent, non-polar solvent, surfactant, organic acid, inorganic acid, base, silane, amine, phosphate, phosphonate, defoamer, stabilizer, wetting agent, buffer, corrosion inhibitor, hydrophobic agent, and a combination thereof. If desired, only the phosphorous acid moiety and a solvent may be present in the coating solution.

In one embodiment, the coating solution and/or rinsing composition may include ethanol, 3:1 ethanol:toluene mixture, or 9:1 ethanol:water. The ethanol toluene and/or ethanol water ratio may be varied as appropriate among any range from 10:1 to 1:10, and any value or subrange therebetween, including ratios of 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, and 1:10.

The coated surface may be dried or cured at a temperature ranging from 20 to 120° C. This range includes all values and subranges therebetween, including 20, 25, 30, 35, 40, 50, 60, 70, 80, 90, 100, 110, 120° C., and any combination thereof.

The drying or curing time for the adherent layer may range from 5 seconds to 2 hour or longer. This range includes all values and subranges therebetween, including 5, 6, 7, 8, 9, 10, 20, 30, 40, 50, 60 seconds, 2, 3, 4, 5, 6, 7, 8, 9, 10, 20, 30, 40, 50, 60, 90, and 120 minutes, and any combination thereof.

Prior to contacting the adherent layer with the polymer to form the functional layer, one or more additional steps may be carried out. Examples of these include heating the adherent layer, removing an excess portion of the coating solution and/or any rinsing compositions from the adherent layer, contacting the adherent layer with an additional rinsing composition, drying the adherent layer, curing the adherent layer, or a combination thereof.

The functional layer may be applied to the adherent layer by dip coating, immersion, roll-coating, squeegeeing, spraying, brushing, vapor deposition, electrophoretic deposition (electrodeposition), doctor blade, polymerization from solution, extruding, contact, or any combination thereof.

After contacting the adherent layer with the polymer, one or more steps may be carried out such as curing the polymer, drying the polymer, heating the polymer, or a combination thereof.

If desired, the polymer may be dried or cured at a temperature ranging from 20 to 200° C. This range includes all values and subranges therebetween, including 20, 25, 30, 35, 40, 50, 60, 70, 80, 90, 100, 110, 120, 130, 140, 150, 160, 170, 180, 190, and 200° C., and any combination thereof.

In one embodiment, the adherent and/or functional layer may be cured by ramping an oven from room temperature to 170° C. at 2°/minute. The article may be held at that temperature for 90 minutes, then cooled slowly to room temperature.

The drying or curing time for the functional layer may range from 30 seconds to 48 hours or longer. This range includes all values and subranges therebetween, including 30, 40, 50, 60 seconds, 2, 3, 4, 5, 6, 7, 8, 9, 10, 20, 30, 40, 50, 60, 90 minutes, 2, 3, 4, 5, 6, 12, 18, 20, 36, 48 hours, and any combination thereof.

A portion of the polymer, adherent layer, or both may be removed as appropriate.

The article of the present invention may be connected to at least one of a heat source, electronic component, or combination thereof, to form a device. For example, the article may be suitable as a heat sink or in other thermally conductive applications. Other devices of the present invention include, for example, electronic circuitry, semiconductor chips, insulated electrical wires, and the like. The article may be contacted to the heat source or electronic component using the functional layer or organophosphonate adherent layer as an adhesive. A heat source may be in thermal contact with the substrate, while an electronic component may be in electrical contact with the substrate.

In one embodiment, the surface of a copper foil is cleaned with 5% H₂SO₄, rinsed with DI water, then dried. The thus cleaned copper foil may then be dipped into a 0.1 mM solution of a coating composition, which includes 11-acetoxyundecylphosphonic acid in 2-butoxyethanol (“CRG 270”) for a time of 10 seconds to 1 minute. The foil is removed from the composition and allowed to dry by hanging at room temperature (25° C.) for about 2-3 minutes. A curing step of heating at 120° C. for 5 minutes may be performed. A heat treatment of the organophosphonate may be carried out to better ensure that the reaction of the phosphonic acid and the copper surface is complete. An optional rinsing step with an appropriate solvent may be performed, after which the coated foil is allowed to dry. The copper foil having a surface coated with the adherent layer is thus obtained. An epoxy polymer functional layer is then coated onto the adherent layer and allowed to cure.

The values and subranges cited herein are set out for illustration purposes only, and are not intended to limit the points within the range unless otherwise specified.

### EXAMPLES

The following examples are provided for purposes of illustration only, and are not intended to be limiting.

### Surface Preparation:

A 1 mM solution of phosphonic acid was prepared in a solution of ethanol (for aniline phosphonic acid, bisphosphonate, olefin terminated phosphonic acid), 3:1 ethanol:toluene mixture (for octadecyl phosphonic acid (ODPA)), 9:1 ethanol:water (for fluorophosphonic acid).

The copper surfaces were cleaned and sonicated in ethanol for 30 minutes, dried in an oven for 30 minutes and dipped into and removed from the appropriate solution for a period of two minutes. Once removed, surfaces were heated with direct heat (from 6 inch distance) with a heat gun. The surfaces were then rinsed and sonicated in the same solvent used to deposit the solution.

For surfaces to be adhesion tested, a small square of epoxy was cut and placed between two coated coupons of copper. Once the epoxy was placed and aligned between the coupons in a vise, the samples were then heat cured. The oven ramping temperature was 2°/minute from room temperature to 170° C. Samples were held at 170° C. for 90 minutes, then cooled slowly to room temperature.

### Interfacial Adhesion of Copper:

Data was conducted by adhering two coated copper surfaces joined together with Cytec Fiberite Epoxy FM 1000. The ASTM Test 1044 was conducted according to the stated protocol within this procedural document, the entire contents of which are hereby incorporated by reference. The table below (Table 1) indicates the results of this test.

TABLE 1

| | Chain | Strength |
|---|---|---|
| Substrate Structure/Terminus | Length | (Mean) |
| Unmodified metal | — | 26.4 MPa |
| Phosphonate | 12 | 48.8 MPa |
| Phosphonate | 4 | 50.6 MPa |
| (with crosslinked olefin in chain) | | |
| Aniline | n/a | 48.5 MPa |
| Olefin terminated | 10 | 59.0 MPa |

### Contact Angle for Copper Surfaces:

Contact Angle was collected using a Rame Hart Model 100 Contact Angle Goniometer with DropImage software.

| | |
|---|---|
| Copper, untreated | 54 degrees |
| Copper, modified with ODPA | 98 degrees |
| Copper, modified with C-10 chain fluorophosphonic acid | 102 degrees |
| Copper, modified with bisphosphonate | 66 degrees |
| Copper, modified with aniline phosphonic acid | 74 degrees |

Infrared Data Collected with Copper Surfaces:

Data collected on Perkin Elmer RX1 Infrared Spectrophotometer, equipped with Diffuse Reflectance Attachment.

Peaks at 2918 cm⁻¹ and 2845 cm⁻¹ indicated the presence of an alkyl chain that persisted upon continued rinsing and sonication with alcohol, toluene and water.

The present invention may be embodied in many different forms, and several embodiments are described herein in detail. It is understood, however, that the embodiments described herein are for illustrative purposes and are not intended to be limiting unless otherwise specified. It is also understood that obvious changes may be made without departing from or exceeding the scope of the invention.

What is claimed is:

1. An article, comprising:
a substrate having a surface and comprising electrodeposited copper foil or copper alloy foil;
an adherent layer, comprising at least one organophosphonate or salt thereof covalently bound to the surface; and
a functional layer, comprising at least one polymer bound to the adherent layer.

2. The article of claim 1, wherein the organophosphonate is derived from an organophosphonic acid moiety having the formula: 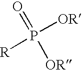
or conjugate base thereof, or salt thereof;
wherein R is a C₁₋₄₀ branched or unbranched, substituted or unsubstituted, saturated or unsaturated aromatic, cyclic, or aliphatic group, optionally having one or more carbons independently replaced with one or more heteroatoms selected from the group consisting of S, N, O, P, and a combination thereof;
wherein R′ is hydrogen or a C₁₋₄₀ branched or unbranched, substituted or unsubstituted, saturated or unsaturated aromatic, cyclic, or aliphatic group, optionally having one or more carbons independently replaced with one or more heteroatoms selected from the group consisting of S, N, O, P, and a combination thereof; and
wherein R″ is hydrogen or a C₁₋₄₀ branched or unbranched, substituted or unsubstituted, saturated or unsaturated aromatic, cyclic, or aliphatic group, optionally having one or more carbons independently replaced with one or more heteroatoms selected from the group consisting of S, N, O, P, and a combination thereof.

3. The article of claim 2, wherein the organophosphonic acid moiety is a substituted or unsubstituted, branched or unbranched, saturated or unsaturated organophosphonic acid or salt thereof, and is selected from the group consisting of alkylphosphonic acid, perfluoroalkylphosphonic acid, hydroxyalkylphosphonic acid, vinylalkylphosphonic acid, phosphonoalkylphosphonic acid, carboxyalkylphosphonic acid, sulfonoalkylphosphonic acid, aminoalkylphosphonic acid, amidoalkylphosphonic acid, siloxyalkylphosphonic acid, alkoxyalkylphosphonic acid, allylalkyl-aryl phosphonic acid, arylalkylphosphonic acid, aldehydealkylphosphonic acid, trifluoromethylalkylphosphonic acid, thioalkylphosphonic acid, epoxyalkylphosphonic acid, nitroalkylphosphonic acid, branched C₃₋₄₀ phosphonic acid, unbranched C₁₋₄₀ phosphonic acid, substituted C₁₋₄₀ phosphonic acid, unsubstituted C₁₋₄₀ phosphonic acid, saturated C₁₋₄₀ phosphonic acid, unsaturated C₂₋₄₀ phosphonic acid, aromatic C₅₋₄₀ phosphonic acid, aliphatic C₁₋₄₀ phosphonic acid, cyclic C₃₋₄₀ phosphonic acid, C₂₋₄₀ phosphonic acid having one or more carbons substituted by S, C₂₋₄₀ phosphonic acid having one or more carbons substituted by N, C₂₋₄₀ phosphonic acid having one or more carbons substituted by O, C₂₋₄₀ phosphonic acid having one or more carbons substituted by P, C₁₋₄₀ phosphonic acid having one or more carbons substituted by a combination of two or more S, N, O, P, salt thereof, and a combination thereof.

4. The article of claim 2, wherein the organophosphonic acid moiety is selected from the group consisting of 11-hydroxyundecylphosphonic acid, 11-acetoxyundecylphosphonic acid, 1-acetoxyundecylphosphonic acid, undec-11-enephosphonic acid, p-aminobenzylphosphonic acid, p-nitrobenzylphosphonic acid, 4-mercaptobutylphosphonic acid, butane-1,4-bisphosphonic acid, but-2-ene-1,4,-bisphosphonic acid, o-phenolphosphonic acid, m-phenolphosphonic acid, p-phenolphosphonic acid, 2 methoxy-4-prop-2-enylphenol-6-phosphonic acid, 1-phosphonic acid-12-mercaptododecane, 1-phosphonic acid-12-(N-ethylamino)dodecane, 1-phosphonic acid-12-dodecene, p-xylylene diphosphonic acid, 1,10-decanediphosphonic acid, 1,12-dodecanediphosphonic acid, 1,14-tetradecanediphosphonic acid, 1-phosphonic acid-12-hydroxydodecane, 1-phosphonic acid-12-(N-ethylamino)dodecane, 1-phosphonic acid-12-dodecene, 1-phosphonic acid-12-mercaptododecane, 1,10-decanediphosphonic acid, 1,12-dodecanediphosphonic acid, 1,14-tetradecanediphosphonic acid, p,p′-biphenyldiphosphonic acid, 1-phosphonic acid-12-acryloyldodecane, 1,8-octanediphosphonic acid, 1,6-hexanediphosphonic acid, 1,4-butanediphosphonic acid, 1,8-octanediphosphonic acid, 1,6-hexanediphosphonic acid, 1,4-butanediphosphonic acid, aminetrimethyleneposphonic acid, ethylenediaminetetramethylenephosphonic acid, hexamethylenediaminetetramethylenephosphonic acid, diethylenetriaminepentamethylenephosphonic acid, 2-phosphonobutane-1,2,4-tricarboxylic acid, aniline phosphonic acid, bisphosphonic acid, olefin terminated phosphonic acid, octadecyl phosphonic acid, fluorophosphonic acid, salt thereof, and a combination thereof.

5. The article of claim 1, wherein the organophosphonate has one of the following formulas: 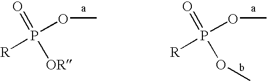
or salt thereof;
wherein R is branched or unbranched, substituted or unsubstituted, saturated or unsaturated, aromatic, cyclic, or aliphatic C₁₋₄₀ group, optionally having one or more carbons independently replaced with one or more heteroatoms selected from the group consisting of S, N, O, P, and a combination thereof;
wherein R″ is hydrogen or a C₁₋₄₀ branched or unbranched, substituted or unsubstituted, saturated or unsaturated aromatic, cyclic, or aliphatic group, optionally having one or more carbons independently replaced with one or more heteroatoms selected from the group consisting of S, N, O, P, and a combination thereof;
wherein a is a covalent bond to the surface; and
wherein b is an electron pair or a bond to at least one selected from the group consisting of the surface, an organophosphonate, an organophosphonic acid, a phosphonate, a phosphonic acid, a metal, an ion, a neighboring molecule, and a combination thereof.

6. The article of claim 5, wherein the organophosphonate is a substituted or unsubstituted, branched or unbranched, saturated or unsaturated organophosphonate or salt thereof, and is selected from the group consisting of alkylphosphonate, perfluoroalkylphosphonate, hydroxyalkylphosphonate, vinylalkylphosphonate, phosphonoalkylphosphonate, carboxyalkyphosphonate, sulfonoalkylphosphonate, aminoalkylphosphonate, amidoalkylphosphonate, siloxyalkylphosphonate, alkoxyalkylphosphonate, allylalkyl-aryl phosphonate, arylalkylphosphonate, aldehydealkylphosphonate, trifluoromethylalkylphosphonate, thioalkylphosphonate, epoxyalkylphosphonate, nitroalkylphosphonate, aniline phosphonate, bisphosphonate, olefin terminated phosphonate, octadecyl phosphonate, fluorophosphonate, branched C₃₋₄₀ phosphonate, unbranched C₁₋₄₀ phosphonate, substituted C₁₋₄₀ phosphonate, unsubstituted C₁₋₄₀ phosphonate, saturated C₁₋₄₀ phosphonate, unsaturated C₂₋₄₀ phosphonate, aromatic C₅₋₄₀ phosphonate, aliphatic C₁₋₄₀ phosphonate, cyclic C₃₋₄₀ phosphonate, C₂₋₄₀ phosphonate having one or more carbons substituted by S, C₂₋₄₀ phosphonate having one or more carbons substituted by N, C₂₋₄₀ phosphonate having one or more carbons substituted by O, C₂₋₄₀ phosphonate having one or more carbons substituted by P, C₁₋₄₀ phosphonate having one or more carbons substituted by a combination of two or more S, N, O, P, salt thereof, and a combination thereof.

7. The article of claim 1, wherein the adherent layer further comprises at least one phosphorous acid moiety selected from the group consisting of organophosphonic acid, phosphonic acid, salt thereof, conjugate base thereof, metal oxide thereof, and a combination thereof.

8. The article of claim 7, wherein the phosphorous acid moiety has the formula: 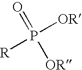
wherein R, R′, R″ are each independently H or a C₁₋₄₀ branched or unbranched, substituted or unsubstituted, saturated or unsaturated, aromatic, cyclic, or aliphatic group, optionally having one or more carbons independently replaced with one or more heteroatoms selected from the group consisting of S, N, O, P, and a combination thereof;
or salt thereof,
or conjugate base thereof,
or metal oxide thereof.

9. The article of claim 7, wherein the phosphorous acid moiety is not bonded to the surface.

10. The article of claim 7, wherein the phosphorous acid moiety is bonded to the surface.

11. The article of claim 1, wherein the substrate comprises an alloy of copper, or oxide thereof, and at least one other metal selected from the group consisting of silver, gold, nickel, palladium, platinum, zinc, titanium, zirconium, vanadium, niobium, tantalum, chromium, molybdenum, tungsten, manganese, iron, ruthenium, osmium, cobalt, zinc, cadmium, aluminum, tin, lead, magnesium, indium, arsenic, antimony, gallium, germanium, bismuth, selenium, tellurium, rhodium, iridium, thallium, silicon, rhenium, scandium, yttrium, oxide thereof, and combinations thereof.

12. The article of claim 1, wherein the copper or copper alloy is electrodeposited onto a core material, wherein the core material comprises an Fe—Ni foil.

13. The article of claim 1, wherein the surface of the substrate has been chemically or mechanically roughened.

14. The article of claim 1, wherein the adherent layer is essentially free of chromium.

15. The article of claim 1, wherein the substrate surface further comprises one or more of an oxide, salt, halide, sulfate, phosphate, hydroxide, chalcogenide, alkoxide, chloride, bromide, iodide, and/or sulfide of copper.

16. The article of claim 1, wherein the surface further comprises one or more of an oxide, halide, sulfate, phosphate, hydroxide, chalcogenide, alkoxide, chloride, bromide, iodide, and/or sulfide of copper, silver, gold, nickel, palladium, platinum, zinc, titanium, zirconium, vanadium, niobium, tantalum, chromium, molybdenum, tungsten, manganese, iron, ruthenium, osmium, cobalt, zinc, cadmium, aluminum, tin, and/or lead.

17. The article of claim 1, wherein the adherent layer comprises an omega-functional organophosphonic acid self-assembled monolayer.

18. The article of claim 1, wherein the polymer in the functional layer is selected from the group consisting of elastomer, epoxy, bisphenol-A epoxy, polyester, polycarbonate, polyphenol, polymercaptan, polyene, polyolefin, polypropylene, polyethylene, polybutylene, polyamide, polyether, polythiophene, polypyrrole, polyimide, polysulfone, polybenzimidazole, polybenzoxazole, poly(p-phenylene), polyquinoline, polyquinoxaline, polysulfide, poly(p-xylylene), polysiloxane, polyurethane, polyphosphazine, alkyd, acrylic, polyvinyl chloride, polystyrene, polyvinyl acetate, polyvinyl alcohol, copolymer thereof, and a combination thereof.

19. The article of claim 1, wherein the functional layer comprises one or more of a dielectric polymer, conducting polymer, semiconducting polymer, thermally conductive polymer, thermally insulating polymer, light emitting polymer, adhesive polymer, minimally adhesive polymer, anticorrosive polymer, antifouling polymer, radiation-reflecting polymer, a polymer-impregnated fiber composite layer, or combination thereof.

20. The article of claim 1, wherein the functional layer contains less than about 0.1 percent by weight of organophosphonate, organophosphonic acid, phosphonic acid, phosphonate, or a mixture thereof, based on the weight of the functional layer.

21. A device, comprising:
a heat source,
a substrate having a surface and comprising electrodeposited copper foil or copper alloy foil;
an adherent layer, comprising at least one organophosphonate or salt thereof covalently bound to the surface; and
a functional layer, comprising at least one polymer bound to the adherent layer, wherein the heat source is in thermal contact with the substrate.

22. A device, comprising:
an electronic component,
a substrate having a surface and comprising electrodeposited copper foil or copper alloy foil;
an adherent layer, comprising at least one organophosphonate or salt thereof covalently bound to the surface; and
a functional layer, comprising at least one polymer bound to the adherent layer, wherein the electronic component is in electrical contact with the substrate.

23. A method for producing an article, comprising:
a) providing a substrate having a surface and comprising electrodeposited copper foil or copper alloy foil;
b) contacting the surface of the substrate with a composition comprising at least one phosphorous acid moiety selected from the group consisting of organophosphonic acid, phosphonic acid, conjugate base thereof, salt thereof, and a combination thereof, to form an adherent layer comprising at least one organophosphonate or salt thereof covalently bound to the surface;
c) contacting the adherent layer with at least one polymer, to covalently bind the polymer to the adherent layer and form a functional layer; and optionally
d) after contacting the adherent layer with the polymer, one or more steps selected from the group consisting of curing the polymer, drying the polymer, heating the polymer, and a combination thereof.

24. The method of claim 23, wherein step c) comprises electrophoretically depositing the polymer onto the adherent layer, wherein the functional layer that is formed comprises a dielectric layer or polyepoxide coating.

25. The method of claim 23, further comprising, prior to contacting the adherent layer with the polymer, at least one step selected from the group consisting of heating the adherent layer, removing an excess portion of the composition from the adherent layer, drying the adherent layer, curing the adherent layer, and a combination thereof.
